(19) United States
(12) Patent Application Publication
(10) Pub. No.: US 2006/0225605 A1
(43) Pub. Date: Oct. 12, 2006

(54) Aqueous coating compositions and process for treating metal plated substrates

(76) Inventors: James R. Kloeckener, Chesterfield, MO (US); Brian S. List, York, SC (US); Paul A. Butkovsky, Lancaster, SC (US); Allen Ray Jones, Weddington, NC (US)

Correspondence Address: Armand P. Boisselle;Renner, Otto, Boisselle & Sklar, LLP, Nineteenth Floor, 1621 Euclid Avenue, Cleveland, OH, 44115, US

(21) Appl. No.: 11/102,976

(22) Filed: Apr. 11, 2005

(51) Int. Cl. C04B 9/02; B05D 1/40; B05D 1/18; B05D 3/00

(52) U.S. Cl. 106/14.13; 427/331; 427/437; 427/443.1

(57) ABSTRACT

An aqueous composition comprising an alkanol amine salt of an aliphatic dicarboxylic acid or anhydride, and alkanol amine, a chelating agent and water is described. The aqueous compositions are useful in treating metal plated substrates to reduce staining and corrosion of the plated substrates.

### FIELD OF THE INVENTION

This invention relates to aqueous compositions, and more particularly, to aqueous compositions useful in treating metal plated substrates to provide a protective coating on the metal plated substrate which provides improved resistance to staining and corrosion.

### BACKGROUND OF THE INVENTION

It is known to plate metallic and non-metallic substrates with continuous deposits of a metal or metal alloy coating. Metals such as tin, silver, bismuth, manganese, copper, nickel, lead, zinc, indium, palladium, platinum, chromium, gold, cadmium, ruthenium, cobalt, gallium and germanium, and mixtures or alloys thereof have been plated onto metallic and non-metallic surfaces utilizing electroless (or chemical) plating and electrolytic plating processes. The metal plated substrates provide desirable properties such as appearance (e.g., brightness, iridescence, satin or matte finishes, etc.) and enhanced adhesion between the plated substrate and polymeric materials subsequently applied to the surface of the substrate. Some of the plating processes which are known have been described as improving staining resistance when plated parts are handled. The moisture and oil in the fingers leave fingerprints like “stains” that are difficult to remove by wiping if allowed to stand for any length of time. It has been suggested that the staining may be a result of slight corrosion from the saline nature of the sweat and oils in the fingers of the hands. There continues to be a need, however, for improved coating compositions for metal substrates which exhibit reduced staining and increased corrosion resistance.

### SUMMARY OF THE INVENTION

In one embodiment, the present invention relates to aqueous compositions which are useful for coating metal plated substrates to reduce staining and provide increased corrosion resistance. In one embodiment, the aqueous compositions of the invention comprise

(A) an alkanol amine salt of an aliphatic dicarboxylic acid containing at least about six carbon atoms in the aliphatic group,

(B) at least one alkanol amine,

(C) at least one chelating agent, and

(D) water, wherein the composition is free of aliphatic monocarboxylic acids.

In another embodiment, the invention relates to a process for treating a metallic or non-metallic substrate which comprises

(A) providing a substrate,

(B) plating the substrate with at least one layer of metal or metal alloy, and

(C) treating the metal plated substrate with an aqueous composition which comprises
(C-1) an alkanol amine salt of an aliphatic dicarboxylic acid containing at least about six carbon atoms in the aliphatic group,
(C-2) at least one alkanol amine, and
(C-3) at least one chelating agent, and
(C-4) water, wherein the composition is free of aliphatic monocarboxylic acids.

In one embodiment, the aqueous compositions also comprise at least one surfactant.

### DESCRIPTION OF EMBODIMENTS OF THE INVENTION

In one embodiment, the aqueous compositions of the invention comprise

(A) an alkanol amine salt of an aliphatic dicarboxylic acid containing at least about six carbon atoms in the aliphatic group,

(B) at least one alkanol amine,

(C) at least one chelating agent, and

(D) water, wherein the composition is free of aliphatic monocarboxylic acids.

In one embodiment, the alkanol amine salts which are included in the aqueous compositions of the present invention are alkanol amine salts of an aliphatic dicarboxylic acid or mixture of dicarboxylic acids containing at least about 6 carbon atoms in the aliphatic group. In another embodiment, the dicarboxylic acid contains from about 6 to about 22, or from about 8 to about 20 carbon atoms in the aliphatic group. Examples of such dicarboxylic acids include 1,6-hexanedicarboxylic acid, (adipic acid), 1,7-heptanedicarboxylic acid, 1,8-octenedicarboxylic acid, 1,10-decanedicarboxylic acid, dodecanedicarboxylic acid, (sebacic acid), 1,11-unadecanedicarboxylic acid, 1,16-hexadecanedicarboxylic acid, 1,18-octadecanedicarboxylic acid, etc.

The alkanol amines which may be combined with the aliphatic dicarboxylic acids (or the corresponding anhydrides and mixtures of two or more dicarboxylic acids) to form the alkanol amine salts may be any one or more of a variety of known alkanol amines. In one embodiment, the alkanol amine salts useful in the aqueous compositions of the present invention may be obtained from an aliphatic dicarboxylic acid containing at least about 6 carbon atoms in the aliphatic group and an alkanol amine represented by the formula
R—N—(X)Y
wherein R is a hydroxyalkyl group, and X and Y are each independently hydrogen, an alkyl group or a hydroxy alkyl group. The alkyl group and the hydroxy alkyl groups, in one embodiment, may contain from about 1 to about 4 or 8 carbon atoms. In another embodiment, the alkyl and hydroxyalkyl contain from 1 to 3 carbon atoms. The alkanol amines useful in forming the salts may be primary, secondary, or tertiary alkanol amines having one or more alcohol functional groups. Examples of alkanol amines containing one alcohol functional group include monoethanolamine (MEA), isopropanolamine, N-dimethylethanolamine, N-diethyl ethanolamine, N-dimethyl isopropanol amine and N-diethyl isopropanolamine. Examples of secondary and tertiary alkanol amines having 2 or 3 alcohol functional groups include, for example, diethanolamine (DEA), N-methyldiethanolamine, N-ethyl diethanolamine, diisopropanolamine, triethanolamine (TEA), and triisopropanolamine. Mixtures of alkanol amines may be utilized in forming the salts of the aliphatic dicarboxylic acids, and mixtures of mono, di and/or trialkanol amines also may be utilized.

Examples of salts which are useful in the aqueous compositions of the invention include: MEA salt of hexanedicarboxylic acid; DEA salt of octanedicarboxylic acid; MEA salt of decanedicarboxylic acid; isopropanolamine salt of decanedicarboxylic acid; MEA salt of dodecanedicarboxylic acid; DEA salt of dodecanedicarboxylic acid; TEA amine salt of dodecanedicarboxylic acid; isopropanolamine salt of octadecanedicarboxylic acid. Mixtures of two or more of such salts also may be included in the aqueous compositions of the invention.

In one embodiment the alkanol amine salts may be prepared in water by mixing one or more alkanol amines and one or more aliphatic dicarboxylic acids in water and heating the mixture to form the desired salt or salt mixture. The mixture is heated to a temperature sufficient to form a clear solution (or dispersion) of the salt. At lower concentrations of the dicarboxylic acid or anhydride (e.g., up to about 15% by weight), mild heating to about 40-50° C. generally is sufficient to form the salts. At higher concentrations of dicarboxylic acid or anhydride, (e.g., up to about 30 or 40% by weight), the mixture may be heated to higher temperatures such as up to about 75° C. to obtain a clear solution.

Examples of commercially available alkanol amine salts of aliphatic dicarboxylic acids which are useful in the present invention include those salts available from Georgia-Pacific Resins, Inc., under the trade names Actracor 856 and Actracor 1987. Actracor 1987 is believed to be the diethanolamine salt of dodecanedioic acid. Salts obtained from Invista™ Corfree® M1 a dibasic acid mixture primarily undecanedioic acid and dodecanedioic acid, available from DuPont, and a mixture of MEA and TEA also are useful in the present invention.

The amount of the alkanol amine salt included in the aqueous compositions may vary over a wide range. Thus, in one embodiment, the aqueous compositions may comprise from about 0.05 to about 50% by weight of the alkanol amine salt. In another embodiment, the concentration may be in the range of from about 0.5 to about 4.5% by weight.

In addition to the alkanol amine salt of an aliphatic dicarboxylic acid containing at least about 6 carbon atoms in the aliphatic group, the aqueous compositions of the present invention also contain added, free or uncombined, alkanol amines. Thus, in one embodiment, the aqueous compositions of the present invention may be obtained by preparing a mixture of a preformed alkanol amine salt of an aliphatic dicarboxylic acid and additional alkanol amine. In another embodiment, the aqueous composition comprising an alkanol amine salt of an aliphatic dicarboxylic acid and additional alkanol amine may be obtained by preparing a mixture of an aliphatic dicarboxylic acid containing at least about 6 carbon atoms in water and adding one or more alkanol amines to the mixture in amounts sufficient to neutralize the aliphatic dicarboxylic acid and to provide additional free or uncombined alkanol amine. When the aqueous compositions of the invention are prepared utilizing a preformed alkanol amine salt and additional alkanol amine, the additional alkanol amine may be the same as the alkanol amine present in the alkanol amine salt, or the uncombined alkanol amine may be different from the alkanol amine of the alkanol amine salt.

The amount of free or uncombined alkanol amine included in the aqueous compositions of the invention also may vary over a wide range. In one embodiment, the aqueous compositions may comprise from about 0.01 to about 25% by weight of the free or uncombined alkanol amine. In another embodiment, the amount may range from about 0.15 to about 2.25% by weight.

The aqueous compositions also contain one or more chelating agents useful in keeping any metal in solution. The chelating agents which are useful in the aqueous compositions of the invention generally comprise the various classes of chelating agents, and specific compounds are disclosed in Kirk-Othmer, Encyclopedia of Chemical Technology, Third Edition, Vol. 5, pp. 339-368. This disclosure is hereby incorporated by reference for its teachings relating to chelating agents. In one embodiment, the chelating agents useful in the present invention comprise polyamines, amino carboxylic acids, polyhydric alcohols, hydroxy carboxylic acids and water soluble salts thereof. Some amino carboxylic acids that may be used comprise ethylenediaminetetraacetic acid (EDTA), hydroxyethyl ethylenediaminetriacetic acid, nitrilotriacetic acid (NTA), and N-dihydroxyethylglycine. Hydroxy carboxylic acids that may be used include tartaric acid, citric acid, gluconic acid and 5-sulfosalicylic acid. Other useful chelating agents include polyamines such as ethylene diamine, dimethyl glyoxine, diethylene triamine, etc. An example of a useful polyhydric chelating agent is sorbitol. When chelating agents are included in the aqueous compositions of the present invention, the chelating agents may be present in amounts of from about 0.005 to about 15% by weight. In another embodiment, when the chelating agents are included in the aqueous compositions of the present invention, the compositions may contain from about 0.05 to about 1.5% by weight of the chelating agent.

In other embodiments, the aqueous compositions of the present invention optionally may contain one or more surfactants compatible with the aqueous compositions. The surfactant may be at least one surfactant including amphoteric, nonionic, cationic and anionic surfactants, or mixtures of two or more thereof.

Nonionic surfactants which can be utilized in the present invention include the condensation products of ethylene oxide and/or propylene oxide with compounds containing a hydroxy, mercapto or primary or secondary amino or amido group, or other nitrogen compound containing at least one N—H group. Examples of materials containing hydroxyl groups include alkyl phenols, styrenated phenols, fatty alcohols, fatty acids, polyalkylene glycols, etc. Examples of materials containing amino groups include alkylamines and polyamines, fatty acid amides, etc.

Examples of nonionic surfactants include ether-containing surfactants having the formula
R—O—[(CH₂)ₙO]ₓH
wherein R is an aryl or alkyl group containing from about 6 to about 20 carbon atoms, n is two or three, and x is an integer between 1 and about 100. Such surfactants are produced generally by treating fatty alcohols or alkyl or alkoxy substituted phenols or naphthols with excess ethylene oxide and/or propylene oxide. The alkyl carbon chain may contain from about 14 to 24 carbon atoms and may be derived from a long chain fatty alcohol such as oleyl alcohol or stearyl alcohol.

Nonionic polyoxyethylene compounds of this type are described in U.S. Pat. No. 3,855,085. Such polyoxyethylene compounds are available commercially under the general trade designations SURFYNOL® by Air Products and Chemicals, Inc. of Wayne, Pa., under the designation MACOL®, PLURONIC® or TETRONIC® by BASF Wyandotte Corp. of Wyandotte, Mich., and under the designation SURFONIC® by Huntsman Corporation of Houston, Tex. Examples of specific polyoxyethylene condensation products useful in the invention include MACOL® LA-23 which is the product obtained by reacting about 23 moles of ethylene oxide with 1 mole of lauryl alcohol. Another example is “SURFYNOL® 465” which is a product obtained by reacting about 10 moles of ethylene oxide with 1 mole of tetramethyldecynediol. “SURFYNOL® 485” is the product obtained by reacting 30 moles of ethylene oxide with tetramethyldecynediol. “PLURONIC® L 35” is a product obtained by reacting 22 moles of ethylene oxide with polypropylene glycol obtained by the condensation of 16 moles of propylene oxide. SURFONIC® N-150 is an ethoxylated alkylphenol.

Alkoxylated amine, long chain fatty amine, long chain fatty acid, alkanol amines, diamines, amides, alkanol amides and polyglycol type surfactants known in the art are also useful. One type of amine surfactant found particularly useful is the group obtained by the addition of a mixture of propylene oxide and ethylene oxide to diamines. More specifically, compounds formed by the addition of propylene oxide to ethylene diamine followed by the addition of ethylene oxide are useful and are available commercially from BASF under the general trade designation TETRONIC®.

Carbowax-type surfactants which are polyethylene glycols having different molecular weights also are useful. For example CARBOWAX® 1000 has a molecular weight range of from about 950 to 1050 and contains from 20 to 24 ethoxy units per molecule. CARBOWAX® 4000 has a molecular weight range of from about 3000 to 3700 and contains from 68 to 85 ethoxy units per molecule. Other known nonionic glycol derivatives such as polyalkylene glycol ethers and methoxy polyethylene glycols which are available commercially can be utilized as surfactants in the compositions of the invention.

Ethylene oxide condensation products with fatty acids also are useful nonionic surfactants. Many of these are available commercially such as under the general trade name ETHOFAT® from Armak Chemical Division of Akzona, Inc., Chicago, Ill. Examples include condensates of oleic acid, linoleic acid, etc. Ethylene oxide condensates of fatty acid amides, e.g., oleamide, also are available from Armak.

Polyoxyalkylated glycols, phenols and/or naphthols also may be included as surfactants. For example ethylene oxide and propylene oxide condensates with aliphatic alcohols, sorbitan alkyl esters, alkyl, alkoxy and styrenated phenols and naphthols are useful additives. About 6 to about 40 moles of the oxide may be condensed with the above identified compound. Many of these condensates are available commercially under such trade names as TWEEN® from ICI America, TRITON® from Rohm & Haas Co., TERGITOL® from Dow Chemical. One example of a useful ethoxylated alcohol surfactant is Tergitol 15-S-12, an ethoxylated C₁₁-C₁₅ secondary alcohol.

The surfactants utilized also may be amphoteric surfactants. Examples of amphoteric surfactants include betaines and sulfobetaines, and sulfated or sulfonated adducts of the condensation products of ethylene oxide and/or propylene oxide with an alkyl amine or diamine.

Typical betaines include lauryldimethylammonium betaine and stearyl dimethylammonium betaine. Sulfated and sulfonated adducts include TRITON® QS-15 (Rohm & Haas Co.), a sulfated adduct of an ethoxylated alkylamine, MIRANOL® HS, a sodium salt of a sulfonated lauric derivative, MIRANOL® OS, a sodium salt of a sulfonated oleic acid, etc. Cationic surfactants also are useful and such surfactants may be selected from the group consisting of higher alkyl amine salts, quaternary ammonium salts, alkyl pyridinium salts and alkyl imidazolium salts.

Cationic surfactants obtained by condensation of various amounts of ethylene oxide and/or propylene oxide with primary fatty amines are useful.

Specific examples of fatty acid amines containing from 8 to 22 carbon atoms include saturated as well as unsaturated aliphatic amines such as octyl amine, decyl amine, lauryl amine, stearyl amine, oleyl amine, myristyl amine, palmityl amine, dodecyl amine, and octadecyl amine.

The alkoxylated amine surfactants are available from the Armak Chemical Division of Akzona, Inc., Chicago, Ill., under the general trade designation ETHOMEEN®. Specific examples of such products include ETHOMEEN® C/15 which is an ethylene oxide condensate of a coconut fatty amine containing about 5 moles of ethylene oxide; ETHOMEEN®C/20 and C/25 which also are ethylene oxide condensation products from coconut fatty amine containing about 10 and 15 moles of ethylene oxide, respectively; ETHOMEEN® S/15 and S/20 which are ethylene oxide condensation products with stearyl amine containing about 5 and 10 moles of ethylene oxide per mole of amine, respectively; and ETHOMEEN® T/15 and T/25 which are ethylene oxide condensation products of tallow amine containing about 5 and 15 moles of ethylene oxide per mole of amine, respectively. Commercially available examples of the alkoxylated amines of the type represented by formula include ETHODUOMEEN® T/13 and T/20 which are ethylene oxide condensation products of N-tallow trimethylene diamine containing about 3 and 10 moles of ethylene oxide per mole of diamine respectively.

The surfactants useful in the compositions of the invention also may be anionic surfactants. Examples of useful anionic surfactants include sulfated alkyl alcohols, sulfated lower ethoxylated alkyl alcohols, and their salts such as alkali metal salts. Examples of such surfactants include sodium lauryl sulfate (Duponol C or QC from Du Pont), sodium mixed long chain alcohol sulfates available from Du Pont under the designation Duponol WN, sodium octyl sulfate available from Alcolac, Ltd. under the designation Sipex OLS, Sodium tridecyl ether sulfate (Sipex EST), sodium lauryl ether sulfate (Sipon ES), magnesium lauryl sulfate (Sipon LM), the ammonium salt of lauryl sulfate (Sipon L-22), diethanolamino lauryl sulfate (Sipon LD), sodium dodecylbenzene sulfonate (SIPONATE® DS), etc.

When a surfactant is included in the aqueous compositions of the present invention, the surfactant will be present in an amount of from about 0.0001 to about 5% by weight. In another embodiment, the aqueous compositions of the present invention may contain from about 0.002 to about 0.3% by weight of one or more surfactants.

The aqueous compositions of the present invention may be obtained by adding the above described components to water in any order. Alternatively, aqueous compositions of the invention may be obtained by first dissolving an aliphatic dicarboxylic acid in water followed by the addition of an amount of an alkanol amine sufficient to neutralize the dicarboxylic acid and provide the desired amount of free alkanol amine. When desired, one or more chelating agents and one or more surfactants, as described above, may be added to the aqueous mixture.

In one embodiment, the aqueous compositions of the present invention may be prepared as concentrates to facilitate storage and shipping. The compositions used in treating substrates may be obtained by adding the concentrates to water at 1-50% by volume. In another embodiment, the concentrates may be diluted by adding the concentrates to water at 5-15% by volume.

In one embodiment, a concentrate may be prepared comprising from about 5 to about 50 (or from about 10 to about 30) percent by weight of at least one dicarboxylic acid salt, from about 1 to about 25 (or about 3-15) percent by weight of free or uncombined alkanol amine, from about 0.5 to about 15 (or about 1 to about 10) percent by weight of one or more chelating agents, and when present from about 0.1 to about 5 (or about 0.05 to about 2) percent by weight of one or more surfactants.

As noted above, the aqueous compositions are free of aliphatic monocarboxylic acid. In another embodiment, the aqueous compositions are also free of mineral oil. In yet another embodiment the aqueous compositions are free of boron compounds capable of reacting with alkanol amines. As used herein, the term “free of” is used to indicate that none of these materials are added to the aqueous compositions of the invention. In one embodiment, minor amounts (e.g., less than 0.1% by weight) of such materials may be present as impurities.

The following examples illustrate the aqueous compositions of the present invention. Examples 1-3 are concentrates, and Examples 4 and 5 are diluted working solutions. Unless otherwise indicated in the following examples, in the claims or elsewhere in the specification, all parts and percentages are by weight, temperatures are in degrees centigrade, and pressure is at or near atmospheric pressure.

| | Weight Percent |
|---|---|
| Example 1 | |
| Water | 85 |
| Actracor 856 | 10 |
| Monoethanolamine | 5 |
| Example 2 | |
| Water | 71.5 |
| Actracor 856 | 18.5 |
| Diethanolamine | 2.0 |
| EDTA | 2.8 |
| Example 3 | |
| Deionized water | 73.57 |
| Actracor ™ 1987 | 16.76 |
| Triethanolamine (85%) | 7.31 |
| Tergitol 15-S-12 | 0.10 |
| Tetrasodium EDTA | 2.26 |
| Example 4 | |
| Deionized water | 97.39 |
| Triethanolamine salt of | 1.7 |
| dodecanedioic acid | |
| Diethanol amine | 0.7 |
| Tetrasodium EDTA | 0.2 |
| Tergitol 15-S-12 | 0.01 |
| Example 5 | |
| Deionized water | 97.35 |
| Actracor ™ 1987 | 1.78 |
| Triethanolamine (85%) | 0.73 |
| Tergitol 15-S-12 | 0.01 |
| Tetrasodium EDTA | 0.23 |

The present invention also provides a process for treating a substrate comprising

(A) providing a substrate,

(B) plating the substrate with at least one layer of metal or metal alloy, and

(C) treating the metal plated substrate with an aqueous composition of the invention as described above.

The substrates useful in the process of the invention may be electrically conductive or non-conductive substrates. In another embodiment, the substrates may be metallic or non-metallic substrates. Examples of conductive or metallic substrates include mild steel, spring steel, chrome steel, chrome-molybdenum steel, copper, copper-zinc alloys, brass, aluminum, zinc and zinc alloys, tin and tin alloys, aluminum alloys, etc.

Alternatively, the substrate may be a non-metallic or non-conductive substrate such as polymer or plastic substrates. Examples of plastic substrates that can be used in the process of the invention include polyamides, ABS, polycarbonates (PC), ABS/PC blends, polypropylenes (PP), thermoplastic olefins (TPO), polyphenylene oxides (PPO), polyimides, polyurethanes (PU), etc.

Additional non-conductive substrates include a wide variety of non-conductive materials, including synthetic resins such as thermoplastic, thermosetting and elastomeric polymers, and glass. In one embodiment, the substrate is a composite material, e.g., epoxy-glass, phenolic-paper, or polyester-glass; and typical composites used in circuit board manufacturing include polyimides for flexible circuitry or high-temperature applications; paper/phenolic which can be readily punched: NEMA grade FR-2; paper/epoxy which has better mechanical properties than the paper/phenolic: NEMA grade FR-3; glass/epoxy and woven glass fabric which have good mechanical properties: NEMA grade FR-4, FR-5; and random glass/polyester which is suitable for some applications: NEMA grade FR-6.

Typical thermosetting polymeric materials which are suitable include polyepoxides; phenolic resins; aminoplastics; unsaturated polyesters; polyimides; and polyamides. Specific thermosetting polymeric materials include the epoxy resins; phenolic resins, e.g., copolymers of phenol, resorcinol and cresol; and polyimides. The non-conductive substrates can be molded from such polymeric materials additionally containing fillers and/or reinforcing agents, such as glass filled epoxy or phenolic base materials. Other additives which may be present in the polymer include natural fibers such as cotton, paper and cellulose; synthetic fibers; carbon black; powdered alumina; fine silica particles; wax and so forth, used as fillers, pigments, reinforcing agents, mold release agents, and so forth.

In one embodiment, the non-conductive substrate is a thermoplastic polymer. The thermoplastic olefins include, among others, polyethylenes and poly(α-olefins) such as poly(1-butene) and poly(1-hexene), wherein the olefin may comprise from 3 to 20 carbon atoms, and may be branched or straight chain compounds. Suitable thermoplastic polymeric materials include polyolefins, such as high and low density polyethylene, polypropylene, polyfluoroethylene, ethylene-propylene copolymers and the like; polyacetals; polyvinyl chloride and copolymers thereof; polyvinyl acetate; polysulfones; polysulfides including polyalkylene sulfides and polyarylene sulfides; polystyrenes and acrylonitrile-butadiene-styrene (ABS) copolymers; polyamides such as poly(hexamethylene adipamide), polycaprolactam, poly(hexamethylene sebacamide), and poly(undecamide); polyimides; polyesterimides; polyetherimides; polycarbonates; polyestercarbonates; polyphenylene oxide; polyacrylics such as poly(methacrylate), polyacrylic acid, and polyacrylonitrile; cellulose esters; polyurethanes; and polyamideimides. In one embodiment, the thermoplastic polymeric material is a polyolefin, e.g., polypropylene; a polysulfone or a polycarbonate. In one embodiment, the polymer is an ABS copolymer. Examples of useful elastomers are natural and synthetic rubbers; silicone rubbers; polyurethane elastomers; and nitrile rubbers.

The foregoing list of non-conductive substrates is intended to be exemplary and is non-limiting. Other non-conducting substrates may be suitably selected by those of skill in the art.

In one embodiment, the conductive and non-conductive substrates are subjected to known processes for pretreating the substrates prior to electroless or electrolytic plating. In one embodiment, the surface of a substrate to be plated is cleaned to remove deposits such as fingerprints, fats and oils and like organic substances, and/or dust deposited due to electrostatic action. Conventional degreasing agents can be used as a treating solution. For example, an alkaline degreasing agent or the like may be used.

In one embodiment, the surface of the substrate may be subjected to etching.

In one embodiment, the step of etching or surface modification includes treatment with a chromic acid (Cr⁶⁺) solution. In one embodiment, the chromic acid solution includes sulfuric acid. The chromic acid concentration in the chromic acid solution may range from about 20% to about 80% by weight. In an embodiment in which sulfuric acid is present in the chromic acid solution, the sulfuric acid concentration may range from about 20% to about 45% by weight.

When chromic acid is used for modifying the surface of a non-conductive substrate, the chromium ions in many instances becomes an unwanted species, undesirable in subsequent steps, due to possible cross contamination and for environmental reasons. In order to remove the chromium ions, in one embodiment, the chromic acid etch step is followed by a step of applying a reducer or neutralizer. This treatment removes hexavalent chromium and reduces it to trivalent chromium, which is much less hazardous than hexavalent chromium. Suitable reducers include, for example, sodium sulfite and sodium bisulfite, acid salts of hydroxylamine or hydrazine, sucrose, sodium borohydride, etc.

Other chemical etchants which may be suitably used include, for example, alkaline permanganate, alkaline amine solutions, sulfuric/nitric acid mixtures, sulfuric/carboxylic acid mixtures and acids such as chloroacetic acid.

In another embodiment, a physical/chemical pretreatment for surface modification of non-conductive substrates is applied prior to the plating process. The surface modification results in a roughened surface having an increased surface area and having an increased susceptibility to attachment of metal ions In subsequent treatment steps. The surface modification treatment may include, for example, a solvent swell, a chromic acid etch, a non-chromic acid etch, a plasma treatment, or other known processes for surface preparation, such as lamination and removal of a roughened metal layer from the non-conductive substrate.

The surface modification treatment may selectively dissolve or remove a portion of the surface of the non-conductive substrate to provide an anchor effect. This treatment can improve the adhesion of the subsequently applied metals. The surface modification is carried out by conventional methods. For example, the substrate to be treated may be immersed in a solution of chromic acid and sulfuric acid.

In one embodiment, the surface modification of polymer substrates includes treatment with solvent which causes the surface of a polymeric non-conductive material to swell and become easier to etch. This may be especially desirable when employing those polymeric materials that are inherently hydrophobic and/or have a very low surface porosity such as various polyimides, including the polyetherimides.

Different pre-treatments are appropriate for different polymers. For example, different polymers are susceptible to different solvents. Some polymers, such as polyamides, should not be treated with strongly acidic agents. Thus, some amount of trial and error may be required in order to optimize an etchant, a solvent or combination of etchant and solvent for use in such pretreatment of a particular polymeric material.

The choice or solvent depends to some degree on the specific polymeric non-conductive material which is to be metallized. Suitable solvents are known in the art, and may be appropriately selected. Suitable solvents include, for example, glycol ether esters such as acetates, N-alkyl pyrrolidones, aliphatic alcohols, aliphatic amines, alkali metal hydroxides, butyl Cellosolve®, (2-butoxy ethanol), butyl Carbitol® (2-(2-butoxyethoxy)ethanol), and ethylene glycol. Other useful solvents include 2-butoxy ethyl acetate (EBA), propylene glycol monomethyl other (Dowanol PM), and propylene glycol monomethyl ether acetate (Dowanol PMA).

Examples of other suitable solvents include amides (e.g. N,N-dimethylformamide and N-methyl-2-pyrrolidone), nitrites (e.g. acetonitrile), amines (e.g. triethanolamine), dimethyl sulfoxide, propylene carbonate, and .gamma.-butyrolactone, ethyl acetate and butyl acetate. N,N-dimethylformamide is especially suitable for pretreatment of polyetherimides. Other solvents include benzaldehyde, ketones such as cyclohexanone, acetone, methyl ethyl ketone, and the like; acetic acid; carbon disulfide; and the like.

Combinations of such solvents may include, for example, an aqueous alkaline solution containing an alkali metal hydroxide and at least one glycol ether or other suitable solvent. In one embodiment, the swelling agent is a combination of an alkali metal hydroxide and a glycol ether mixture. In another embodiment, a mixture of butyl Cellosolve® butyl Carbitol® and ethylene glycol is used. Surfactants may be combined with the foregoing solvents as appropriate.

The surface modification pretreatment may be carried out at an appropriate temperature, for example, a temperature ranging from about 0° C. to about 100° C. In one embodiment, the surface modification pretreatment is carried out at temperature in the range from about 15° C. to about 50° C., or about 25° C. to about 35° C., or at about room temperature.

The surface modification pretreatment may be carried out for an appropriate time, for example, a time ranging from about 1 second to about 100 minutes. In one embodiment, the surface modification pretreatment is carried out for a time from about 30 seconds to about 5 minutes.

Plasma treatment may be used in the surface modification pretreatment of the surface of the non-conductive substrate. Plasma treatment of polymeric surfaces may improve the surface properties, e.g., the surface may be roughened or rendered more susceptible to attachment of metal ions in subsequent steps. Suitable plasmas include, for example, plasmas of an inert gas or oxygen, various lower hydrocarbons (e.g., methane or butane), and combinations of agents, e.g., water and ethanol. Sequential plasma surface treatments are also known such as those comprising a first treatment with a plasma of an inert gas or oxygen, followed by a hydrocarbon plasma. Such plasma treatments may be appropriately selected.

Plasma pretreatment may be appropriate, rather than solvent pretreatment, depending on the nature of the non-conductive surface, and on other considerations such as the environment or economics.

After the surface modification pretreatment, the polymer substrate is washed to remove any etching solution, such as chromic acid or the like, remaining on the surface of resin substrate. Chromic acid may be removed from the surface when cleaning is effected using a diluted solution of hydrochloric acid or, as noted above, by using a solution containing a reducing agent such as sodium bisulfite. In one embodiment, a reducing agent is included in the following surface conditioning step, thus avoiding the necessity of adding an additional step of neutralizing any remaining oxidation agents.

In one embodiment, the non-conductive surface is treated with a conditioning agent. The conditioning agent may be applied independently of the surface modification pretreatment, although in general the surface conditioning, when present, follows the surface modification pretreatment of the non-conductive surface, when present.

In one embodiment, the conditioning agent comprises a surfactant. The surfactant may be one or more of nonionic, anionic, cationic or amphoteric surfactants. Suitable surfactants are those disclosed below for use in the electroless deposition.

In one embodiment, the conditioning agent comprises a neutralizing or reducing agent, to remove and/or reduce any remaining chromic acid. In one such embodiment, a neutralizing and/or reducing agent is included in the conditioning agent, and a separate step of neutralizing and/or reducing the chromic acid need not be applied following a chromic acid etching step, prior to the conditioning step.

In one embodiment, in the conditioning step, a neutralizer comprising an acid salt of a reducing agent is applied to the non-conductive substrate. The reducing agent may be one or more of hydrazine, which may be present as a derivative such as hydrazine hydrate, hydrazine sulfate, neutral hydrazine sulfate or hydrazine maleate, hydroxylamine, mono-, di- or triethanolamine, glyoxylic acid, aldehydes such as formaldehyde, benzaldehyde, glyoxal, vanillin or acetaldehyde, hypophosphite, hydrogen borate such as NaBH₄ or KBH₄, N-dimethylamine borane (DMAB), N-diethylamine borane (DEAB), sodium thiosulfate, sodium ascorbate, monosaccharide, disaccharide or polysaccharide, for example, sucrose. The acid of the acid salt of a reducing agent may be a mineral acid such as hydrochloric, sulfuric or phosphoric, or it may be a sulfonic acid, or it may be a carboxylic acid.

Other examples of monosaccharide include, among others, glucose, dextrose, glucolactone, glucopyranose, fructose and any of mixtures of these substances. Examples of disaccharide include, among others, saccharose, lactose, maltose and any of mixtures of these substances. Examples of polysaccharide include, among others, alginic acid, cellulose, starch, glycogen, pullulan and any of mixtures of these substances.

In one embodiment, the neutralizer is Futuron® Neutralizer, which contains an acid salt of a reducing agent, and is available from Atotech Deutschland GmbH.

In one embodiment, in the conditioning step, a conditioner comprising at least one surfactant and at least one aliphatic amine is applied to the non-conductive substrate. In one embodiment, the at least one surfactant is one or more of nonionic, anionic, cationic or amphoteric surfactants. In one embodiment, the conditioner further comprises a complexing agent.

In one embodiment, the conditioner is Conditioner CC-301, which contains a mixture of surfactants and aliphatic amines, and is available from Atotech Deutschland GmbH. In another embodiment, the conditioner is Futuron®-C Conditioner, which also contains a mixture of surfactants and aliphatic amines, and is available from Atotech Deutschland GmbH.

In one embodiment, a combination or mixture of a neutralizer and a conditioner, each as described above, is applied to the non-conductive surface. In one such embodiment, a combination of Futuron® Neutralizer and Conditioner CC-301 are employed. In another such embodiment, a combination of Futuron®Neutralizer and Futuron®C Conditioner is employed.

The conditioning step may be carried out at an appropriate temperature, for example, a temperature ranging from about 0° C. to about 100° C. In one embodiment, the conditioning step is carried out at temperature in the range from about 15° C. to about 50° C., or about 25° C. to about 35° C., or at about room temperature.

The conditioning step may be carried out for an appropriate time, for example, a time ranging from about 1 minute to about 100 minutes. In one embodiment, the conditioning step is carried out for a period from about 2 to about 5 minutes.

In one embodiment, following the initial steps of surface modification, conditioning and other preparation, the non-conductive surface may be treated with a sensitizing solution in a sensitizing step. In one embodiment, the sensitizing solution comprises an aqueous solution of tin (II) (Sn²⁺). The tin (II) may be provided as SnCl₂, SnSO₄, SnF₂, Sn(CH₃ SO₃)₂, tin oxalate, or other suitable, solution soluble salt of tin (II). The tin (II) salt may be dissolved in an acid which corresponds to the salt, or in another suitable acid. For example, SnCl₂ may be dissolved in an aqueous solution of hydrochloric acid, and SnSO₄ may be dissolved in an aqueous solution of sulfuric acid, and Sn(CH₃ SO₃)₂ may be dissolved in an aqueous solution of methane sulfonic acid. Alternatively, the tin (II) salt may be dissolved in an acid which does not correspond to the salt counterion.

The tin (II) salt may be present in the sensitizing solution at a concentration in the range from about 0.1 g/l to about 250 g/l. In one embodiment, the tin (II) is present in the sensitizing solution at a concentration in the range from about 1 g/l to about 100 g/l, or about 5 g/l to about 50 g/l, or about 10 g/l to about 25 g/l, or at about 10 g/l. In one embodiment, the tin (II) salt is present as a saturated solution, i.e., at the limit of its solubility in the aqueous medium in which it is dissolved.

The sensitizing step may be carried out at an appropriate temperature, for example, a temperature ranging from about 0° C. to about 100° C. In one embodiment, the sensitizing step is carried out at temperature in the range from about 15° C. to about 50° C., or about 25° C. to about 35° C., or at about room temperature.

The sensitizing step may be carried out for an appropriate time, for example, a time ranging from about 0.1 minute to about 100 minutes. In one embodiment, the sensitizing step is carried out for a period from about 30 seconds to about 10 minutes, or about 1 minute to about 5 minutes, or about 2 minutes.

Following the sensitizing step, the sensitized non-conductive surface may be treated with a noble ion-containing catalyzing solution in a catalyzing step. The catalyzing solution comprises an aqueous solution of a noble metal such as palladium, silver and gold. In one embodiment, the sensitizing solution comprises an aqueous solution of palladium chloride and hydrochloric acid in water at a pH of about 1. In another embodiment, silver ions are provided to a catalyzing solution in the form of silver nitrate or silver sulfate. The silver ions may be provided in the form of other silver compounds, but silver nitrate is the most common and easily available silver salt, and it is quite soluble in water.

When silver ion is present in a solution having a pH in the range from about 5 to about 10, excellent catalysis for electroless plating of a polymer substrate is obtained. In one embodiment, the solution has a pH in the range from about 6 to about 9.

In one embodiment, the catalyzing solution comprises, in addition to the noble metal ion, an agent such as monoethanolamine, diethanolamine or triethanolamine and complexing agents for silver ion.

The noble metal salt may be present in the catalyzing solution at a concentration in the range from about 0.1 g/l to about 250 g/l. In one embodiment, the noble metal is present in the catalyzing solution at a concentration in the range from about 0.5 g/l to about 100 g/l, or about 5 g/l to about 50 g/l, or about 10 g/l to about 25 g/l, or at about 10 g/l.

The catalyzing step may be carried out at an appropriate temperature, for example, a temperature ranging from about 0° C. to about 100° C. In one embodiment, the catalyzing step is carried out at temperature in the range from about 15° C. to about 50° C., or about 25° C. to about 35° C., or at about room temperature.

The catalyzing step may be carried out for an appropriate time, for example, a time ranging from about 0.1 minute to about 100 minutes. In one embodiment, the catalyzing step is carried out for a period from about 30 seconds to about 10 minutes, or about 1 minute to about 5 minutes, or about 2 minutes.

In the process of the invention, the substrate which may be pretreated as described above, is plated with at least one layer of a metal or metal alloy using an electroless process. Two or more layers of metal or metal alloys can be deposited using additional electroless and/or electrolytic processes. For example, a substrate can be electroless plated to deposit a layer of one or more metals or an alloy, followed by electrolytic plating of the same or a different metal or alloy. As many as 5 or 6 layers of metal, or more, may be plated onto the substrates.

Electroless and electrolytic plating processes are well known in the art. Metals which can be plated utilizing electrolytic processes include nickel, tin, silver, bismuth, chromium, copper, lead, zinc, manganese, indium, palladium, platinum, gold, cadmium, ruthenium, cobalt, gallium and germanium, and alloys of these metals. Nickel, copper, cobalt, and nickel-cobalt alloys are among the metals that can be plated using electroless processes.

The conductive metallic and non-conductive substrates may be plated with one or more layers of metal in the electroless process by contacting the substrate with one or more of the plating compositions by immersing or dipping the surface into the electroless plating composition maintained at a temperature of from about 0 to about 95° C. in a continuous or batch process. The plating times may vary in accordance with the desired thickness of the deposited electroless plated metal coating or layer. In one embodiment, the substrate is immersed in the electroless plating composition for about 1 minute up to about 120 minutes. The time may be selected so as to provide the desired metal coating quality and thickness. The plated metal may be applied in one or more layers ranging from about 0.01 to about 1 mil or more.

As mentioned above, electroless plating compositions and processes are well known in the art and are available commercially. Any of these processes and plating compositions may be used to plate the substrates prior to treatment with the aqueous compositions of the invention described above. For example, U.S. Pat. No. 6,800,121 describes an electroless nickel plating solution and process based on nickel salts of alkyl sulfonic acids as the source of nickel ions. The nickel plating solutions contain hypophosphorous acid or salt thereof as a reducing agent. U.S. Pat. No. 6,645,557 describes processes and solutions for metal plating of plastic surfaces. The disclosures of U.S. Pat. Nos. 6,800,121 and 6,645,557 are hereby incorporated by reference.

Noviganth® LFS is an electroless nickel plating process designed to metallize plastic substrates prior to electrodeposition. This process is a low temperature alkaline process available from Atotech USA, Inc., Rock Hill, S.C. In the Noviganth® system, a plastic substrate is treated with a Noviganth Activator and Noviganth Accellerator 400 prior to electroless nickel plating in Noviganth® LFS. Another electroless nickel plating bath available from Atotech USA is Nichem 2500 which is useful, in one embodiment, over zinc surfaces or zincated aluminum surfaces.

As noted above, conductive substrates also may be plated with one or more layers of metal or metal alloys using an electrolytic process. In an electrolytic process, an electrolytically conducting substrate of metal is provided with a coating of any of the above described metals or metal alloys. In one embodiment, the deposition of the coatings electrolytically is carried out at a current density in the range of from about 0.01 to about 150 A/d m², and the process conveniently may be carried out at room temperature, or at a lower or higher temperature.

Electrolytic processes may be carried out, for example, as a drum electroplating process when used for mass parts, and as a frame galvanizing or rack process for depositing on larger workpieces. In this connection, anodes are used that may be soluble, and the anodes at the same time serve as a source of the metal ions so that the metal deposited on the cathode is recovered by disolution of the metal at the anode. Alternatively, insoluble anodes such as, for example, carbon or platinized titanium anodes may be used, in which case, the metal ions are removed from the electrolyte and have to be replenished in another way, for example, by using a metal dissolving tank or vendor supplied metal salt concentrates.

Electrolytic nickel plating materials and processes are available from Atotech USA under the general trade designations: MPS-100, a particle nickel process; Mark® 90, a semi-bright nickel plating process; Uni-Brite® B-100; a process for depositing a bright nickel plating; and Satilume® Plus, a process for producing non-reflective, matte, satin nickel deposits. An example of an electrolytic process for depositing copper which is available from Atotech USA is Cupracid® 300.

In one embodiment, the conductive substrates may be plated with chromium prior to treatment with the aqueous compositions described above. The application of a chromium deposit on the substrate can be accomplished by procedures well known in the art, and these procedures generally utilize electrolytic processes involving chromium solutions. The chromium plating bath may comprise trivalent chromium, hexavalent chromium, or mixtures thereof. These baths generally are intended for either “decorative” chromium plating or for “functional” (hard) chromium deposition. Functional hexavalent chromium plating baths generally contain chromic acid and sulfate as a catalyst. In other embodiments, the chromic acid plating baths may contain a mixture of catalysts including both sulfate and fluoride ions which generally allow the plating of chromium at higher rates and higher cathode efficiencies.

It also has been suggested to utilize organic sulfonic acids in the chromic acid and sulfate plating baths. Examples of such organic sulfonic acids or polysulfonic acids include methyl sulfonic acid, ethyl sulfonic acid, propyl sulfonic acid, methane disulfonic acid, 1,1-ethane disulfonic acid, etc. Chromic acid and sulfate plating baths containing organic sulfonic acids have been described in, for example, U.S. Pat. No. 4,588,481, the disclosure which is hereby incorporated by reference.

A number of chromium plating processes available commercially from Atotech USA are useful in chromium plating the substrates prior to treatment with the aqueous compositions of the present invention. HEEF® 25 is a high speed chromium plating process that deposits functional (hard) chromium. HEEF® 25 contains chromic acid, sulfate ions and an organic disulfonic acid. Tri-Chrome® Smoke is a trivalent chromium plating process available from Atotech USA that produces a unique grayish black finish over bright nickel-plated surfaces. The Tri-Chrome® Smoke process is an adaptation of Atotech's Tri-Chrome® process which utilizes an addition agent, TC Darkening Agent, to achieve the desired plated finish. Tri-Chrome® PLUS is a trivalent chromium plating process available from Atotech which does not utilize chromic acid. In addition to trivalent chromium, the plating solutions utilized in this process include boric acid. BRASS ELECTRO CHROMATE is another chromate process available from Atotech USA which provides a process for depositing chromate coatings on brass or other metal surfaces.

The aqueous compositions of the invention described above and comprising an alkanol amine salt of an aliphatic dicarboxylic acid, an alkanol amine, a chelating agent and, optionally, a surfactant are useful, in one embodiment in treating the above described metal plated substrates to increase the stain resistance of the metal plating and improve corrosion resistance. In one embodiment, the metal plated substrates can be treated with the aqueous composition by immersion, spraying, cascading, etc. for a period of about 10 seconds to about 4 or 5 minutes as desired. In one embodiment, the surface of a metal plated substrate is contacted with the aqueous composition (e.g, by immersion) at about 50° C. for about 0.5 to 2 minutes. In another embodiment, the temperature of the composition may be within the range of from about 25 or 30° C. to about 70 or 80° C.

After treatment with the aqueous compositions, the treated metal plated substrates are air dried. In one embodiment, the air dried treated substrates are rinsed with water and again air dried.

The application of the process of the invention is illustrated in the following Examples.

### EXAMPLE A

Twelve steel rods which are first subjected to a pretreatment wherein the steel rods are:

(1) cleaned with paper towels,

(2) scrubbed with a pumice cleaner (e.g., AJAX),

(3) rinsed with water,

(4) cleaned in an alkaline cleaner (e.g., Uniclean Electro XS-L from Atotech USA) without current,

(5) rinsed with water, and

(6) etched for 5 seconds using a HEEF® 25 solution reversing the current (3 ASI) from the normal chromium electroplating.

The pretreated steel rods are then plated with a layer of chromium using the same HEEF® 25 plating solution containing 250 g/l of CrO₃ and 2.5 g/l of sulfate. Lead alloy anodes are used, and the plating operating conditions are: temperature of 60° C., and cathode current density of 3 amperes/in² (ASI) for thirty minutes with very low magnetic stirring. A chromium deposit of 25 microns is obtained.

After plating with chromium, four of the plated rods are not treated with the aqueous compositions of the invention and are identified as Controls. Four of the chromium plated rods are immersed in the aqueous composition of Example 5 for one minute and then air dried. The final four rods are immersed in the composition of Example 5 for one minute, air dried, rinsed in deionized water and again air dried.

The twelve steel rods were subjected to a Neutral Salt Spray Test (NSST) (ASTM B117) after the untreated parts of the rods were taped. The NSST results are summarized in the following Table (average of four rods), and the results demonstrate that the rods that were treated with the composition of Example 5, air dried, rinsed with water and again air dried, exhibit improved corrosion resistance.

TABLE
Percent Of Sample With No Visible Corrosion

| Salt Spray | Substrate Treatment | | |
|---|---|---|---|
| Exposure (hrs) | Controls | Ex. 5 | Ex. 5 + Water Rinse |
| 0 | 100 | 100 | 100 |
| 8 | 100 | 75 | 100 |
| 24 | 25 | 0 | 100 |
| 28 | 25 | 0 | 100 |
| 32 | 25 | 0 | 75 |
| 48 | 0 | 0 | 50 |
| 56 | 0 | 0 | 50 |
| 72 | 0 | 0 | 25 |
| 96 | 0 | 0 | 0 |

A series of experiments were conducted on ABS automotive parts to demonstrate the utility of the aqueous compositions in providing increased corrosion resistance to metal plated plastic substrates. Cleaned ABS parts are cleaned and plated as follows:
(1) Normal preplate cycle for ABS plastic with Noviganth® LFS electroless nickel plating process to deposit a nickel coating (10 millionths of an inch);
(2) Acid copper strike and acid copper plate (Cupracid® 300) for total copper thickness of 0.0005 inch;
(3) Semi bright nickel plating with Mark® 90;
(4) High sulfur nickel plating using HSA-90 addition agent;
(5) Bright nickel plating with Uni-Brite® B-100;
(6) Particle nickel plating with MPS-100; wherein total nickel plating thickness over the upper layer is 0.0016 inch.

### EXAMPLE B

ABS parts preplated as described above are electrolytically coated with a chromium layer using Tri-Chrome® Smoke including TC Darkening Agent at 6-8% and 80 ppm iron max. The Tri-Chrome® Smoke is run for 20 minutes at 100 ASF, a temperature of 70° F. (21° C.), and a pH of 3.8-4.1. These treated parts are identified as Control B.

Some of the chromium plated ABS parts are treated with the aqueous composition of Example 5 by immersion for one minute at 120° F. (50° C.), removed from the aqueous composition, rinsed with water and dried. The treated and untreated samples (Control B) were subjected to the Copper Accelerated Salt Spray (CASS) in accordance with ASTM B368. The control samples (Control B) achieved 24-35 hours CASS to failure. The treated samples achieved 88 hours CASS to failure.

### EXAMPLE C

Some of the chromium plated ABS parts (Control B) prepared in Example B are electroplated with a second chromium layer utilizing the Brass Electro Chromate process available from Atotech USA. The plating solution comprises 22 oz/gal of chromium and 25 oz/gal of caustic. The process is operated at a pH of about 2.5 and a temperature of about 60° C. for about 4 minutes at 25 ASF. These treated parts are identified as Control C.

Some of the Control C parts are then treated with the aqueous composition of Example 5 by immersion for one minutes at 120° F. (50° C.), rinsed with water and dried to give a clear coating.

The Control C parts achieved 48-66 hours CASS to failure, and the Control C parts treated with the aqueous composition of Example 5 achieved 90-114 hours CASS.

While the invention has been explained in relation to its various embodiments, it is to be understood that other modifications thereof will become apparent to those skilled in the art upon reading the specification. Therefore, it is to be understood that the invention disclosed herein is intended to cover such modifications as fall within the scope of the appended claims.

1. An aqueous composition comprising
(A) an alkanol amine salt of an aliphatic dicarboxylic acid containing at least about six carbon atoms in the aliphatic group,
(B) at least one alkanol amine,
(C) at least one chelating agent, and
(D) water, wherein the composition is free of aliphatic monocarboxylic acids.

2. The composition of claim 1 also comprising at least one surfactant.

3. The composition of claim 1 wherein the aliphatic dicarboxylic acid of (A) contains from about 6 to about 22 carbon atoms in the aliphatic group.

4. The composition of claim 1 wherein the alkanol amine of the salt (A) and the alkanol amine (B) are each independently represented by the formula
R—N—(X)Y
wherein R is a hydroxyalkyl group, and X and Y are each independently hydrogen, an alkyl group or a hydroxyalkyl group.

5. The composition of claim 1 wherein the alkanol amine of the salt (A) and the alkanol amine (B) are each independently selected from monoethanolamine, diethanolamine, triethanolamine, isopropanolamine, N-diethylethanolamine, N-dimethyl isopropanolamine, N-methyldiethanolamine, and N-ethyldiethanolamine.

6. The composition of claim 2 wherein the surfactant is a nonionic surfactant.

7. The composition of claim 1 wherein the composition is free of mineral oil.

8. The composition of claim 1 which is free of boron compounds capable of reacting with the alkanol amine.

9. An aqueous composition comprising
(A) an alkanol amine salt of an aliphatic dicarboxylic acid containing at least about six carbon atoms,
(B) at least one alkanol amine, and
(C) at least one metal chelating agent, and
(D) at least one surfactant, and
(E) water, wherein the composition is free of aliphatic monocarboxylic acids.

10. The composition of claim 9 wherein the alkanol amine of the salt (A) and the alkanol amine (B) are each independently represented by the formula
R—N—(X)Y
wherein R is a hydroxyalkyl group, and X and Y are each independently hydrogen, an alkyl group or a hydroxyalkyl group.

11. The composition of claim 9 wherein the aliphatic dicarboxylic acid of (A) contains from about 6 to about 22 carbon atoms in the aliphatic group.

12. The composition of claim 11 which is free of mineral oil.

13. The composition of claim 9 comprising
(A) from about 0.05 to about 50% by weight of the alkanol amine salt,
(B) from about 0.01 to about 25% by weight of the alkanol amine,
(C) from about 0.005 to about 15% by weight of the chelating agent,
(D) from about 0.0001 to about 5% by weight of the surfactant, and
(E) water.

14. The composition of claim 9 comprising
(A) from about 0.5 to about 4.5% by weight of the alkanol amine salt,
(B) from about 0.15 to about 2.25% by weight of the alkanol amine,
(C) from about 0.05 to about 1.5% by weight of the chelating agent,
(D) from about 0.002 to about 0.30% by weight of the surfactant, and
(E) water.

15. The composition of claim 9 which is free of boron compounds capable of reacting with the alkanol amine.

16. A process for treating a metal plated substrate to improve corrosion resistance and resistance to staining comprising
(A) providing a substrate,
(B) plating the substrate with at least one layer of metal or metal alloy, and
(C) treating the metal plated substrate with an aqueous composition of claim 1.

17. The process of claim 16 wherein the substrate is a polymer or metal.

18. The process of claim 16 wherein the substrate is a non-conductive substrate.

19. The process of claim 16 wherein a chromate coating is applied to the metal plated substrate before the metal plated substrate is treated with an aqueous composition of claim 1.

20. The process of claim 16 wherein the substrate is plated with at least one layer of metal or metal alloy utilizing electroless or electrolytic plating processes.

21. The process of claim 16 wherein the metal is selected from tin, silver, chromium, bismuth, copper, nickel, manganese, lead, zinc, indium, palladium, platinum, gold, cadmium, ruthenium, cobalt, gallium and germanium, and alloys thereof.

22. The process of claim 16 wherein the substrate is cleaned and etched prior to plating.

23. The process of claim 16 wherein the substrate is a polymer substrate, and the polymer substrate is plated with at least one layer of electroless nickel or copper, then plated with electrolytic copper, and thereafter plated with one or more layers of nickel prior to treatment with an aqueous composition of claim 1.

24. The process of claim 23 wherein the copper plated and nickel plated polymer substrate is provided with a chromium coating from a trivalent chromium electroplating bath before the plated substrate is treated with the aqueous composition of claim 1.

25. The process of claim 24 wherein the chromium coating on the plated polymer substrate is provided with a chromate coating before the plated substrate is treated with an aqueous composition of claim 1.

26. The process of claim 16 wherein the substrate is a metal substrate, and the metal substrate is plated with chromium.

27. The process of claim 26 wherein the chromium is deposited from a hexavalent hard chromium electroplating bath.

28. The process of claim 16 wherein the treated metal plated substrate obtained in (C) is dried, rinsed with water and again dried.

29. A process for treating a substrate comprising
(A) providing a substrate,
(B) plating the substrate with at least one layer of metal or metal alloy,
(C) treating the metal plated substrate with an aqueous composition of claim 9.

30. The process of claim 29 wherein the treated metal plated substrate obtained in (C) is rinsed with water and dried.

31. The process of claim 29 wherein the treated metal plated substrate obtained in (C) is dried, rinsed with water and again dried.

32. The process of claim 16 wherein the substrate is a metal substrate, and the metal substrate is plated with at least one layer of electroless nickel in (B).
